(19) United States
(12) Patent Application Publication
(10) Pub. No.: US 2025/0334974 A1
(43) Pub. Date: Oct. 30, 2025

(54) FLIGHT OPERATION RESOURCE USAGE PREDICTION AND OPTIMIZATION

(71) Applicant: Honeywell International Inc., Charlotte, NC (US)

(72) Inventor: Ranga Udipi, Bangalore (IN)

(21) Appl. No.: 19/193,397

(22) Filed: Apr. 29, 2025

(30) Foreign Application Priority Data
Apr. 30, 2024 (IN) 202411034182

(51) Int. Cl. G05D 1/644; G05D 101/15

(52) U.S. Cl. CPC G05D 1/644; G05D 2101/15

(57) ABSTRACT

Various embodiments of the present disclosure provide techniques for flight operation resource usage prediction and optimization. The techniques may include identifying input data set for a prospective flight operation having an estimated operating starting timestamp, the input data set associated with a first timestamp preceding the estimated operating starting timestamp; generating initial resource usage prediction for the prospective flight operation by applying one or more models to the input data set; generating one or more refined resource usage predictions for the prospective flight operation, each refined resource usage prediction associated with a subsequent timestamp of one or more sequential subsequent timestamps relative to the first timestamp and preceding the estimated operating starting timestamp; and initiating performance of one or more prediction-based actions based on one or more of the initial resource usage prediction or the one or more refined resource usage predictions.

### CROSS REFERENCE TO RELATED APPLICATIONS

This application claims priority to India application No. 202411034182, filed on Apr. 30, 2024, the contents of which are hereby incorporated herein by reference in their entirety.

### TECHNOLOGICAL FIELD

The present disclosure relates, generally, to flight operation resource usage prediction and optimization. Example embodiments are directed to systems, apparatuses, methods, and computer program products for flight operation resource usage prediction and optimization.

### BACKGROUND

Various embodiments of the present disclosure address technical challenges related to flight operation resource usage prediction. Through applied effort, ingenuity, and innovation, Applicant has solved problems related to flight operation resource usage prediction by developing solutions embodied in the present disclosure, which are described in detail below.

### BRIEF SUMMARY

In general, embodiments of the present disclosure provide systems, apparatuses, methods, and computer program products for flight operation resource usage prediction and optimization.

In accordance with an aspect of the disclosure a computer-implemented method for resource usage prediction and optimization is provided. In an example embodiment, the computer-implemented method comprises identifying an input data set for a prospective flight operation having an estimated operating starting timestamp, the input data set associated with a first timestamp preceding the estimated operating starting timestamp for the prospective flight operation; generating initial resource usage prediction for the prospective flight operation by applying one or more models to the input data set; generating, one or more refined resource usage predictions for the prospective flight operation, each refined resource usage prediction of the one or more refined resource usage predictions associated with a subsequent timestamp of one or more sequential subsequent timestamps relative to the first timestamp and preceding the estimated operating starting timestamp for the prospective flight operation; and initiating performance of one or more prediction-based actions based on one or more of the initial resource usage prediction or the one or more refined resource usage predictions.

In accordance with another aspect of the disclosure, a computing system for resource usage prediction and optimization is provided. In some embodiments, the computing system comprises memory and one or more processors communicatively coupled to the memory, the one or more processors configured to identify an input data set for a prospective flight operation having an estimated operating starting timestamp, the input data set associated with a first timestamp preceding the estimated operating starting timestamp for the prospective flight operation; generate initial resource usage prediction for the prospective flight operation by applying one or more models to the input data set; generate, one or more refined resource usage predictions for the prospective flight operation, each refined resource usage prediction of the one or more refined resource usage predictions associated with a subsequent timestamp of one or more sequential subsequent timestamps relative to the first timestamp and preceding the estimated operating starting timestamp for the prospective flight operation; and initiate performance of one or more prediction-based actions based on one or more of the initial resource usage prediction or the one or more refined resource usage predictions.

In accordance with another aspect of the disclosure at least one non-transitory computer-readable storage medium for flight operation resource usage prediction and optimization is provided, the at least one non-transitory computer-readable storage medium having computer coded instructions configured to, when executed by at least one processor identify an input data set for a prospective flight operation having an estimated operating starting timestamp, the input data set associated with a first timestamp preceding the estimated operating starting timestamp for the prospective flight operation; generate initial resource usage prediction for the prospective flight operation by applying one or more models to the input data set; generate, one or more refined resource usage predictions for the prospective flight operation, each refined resource usage prediction of the one or more refined resource usage predictions associated with a subsequent timestamp of one or more sequential subsequent timestamps relative to the first timestamp and preceding the estimated operating starting timestamp for the prospective flight operation; and initiate performance of one or more prediction-based actions based on one or more of the initial resource usage prediction or the one or more refined resource usage predictions.

It should be appreciated that any and/or all aspects and/or operations of the example computer-implemented methods described herein may be combinable with any other of the aspects and/or operations of any other of the example computer-implemented methods described herein.

### BRIEF DESCRIPTION OF THE DRAWINGS

FIG. 1 provides an example overview of an architecture in accordance with at least some embodiments of the present disclosure.

FIG. 2 provides an example predictive data analysis computing entity in accordance with at least some example embodiments of the present disclosure.

FIG. 3 provides an example client computing entity in accordance with at least some example embodiments of the present disclosure.

FIG. 4 is a dataflow diagram showing example data structures for flight operation resource usage prediction and optimization in accordance with at least some example embodiments of the present disclosure.

FIG. 5A illustrates a data environment for input data aggregation in accordance with at least some example embodiments discussed herein. in accordance with some example embodiments of the present disclosure.

FIG. 5B illustrate examples of certain input parameters in accordance with at least some example embodiments of the present disclosure.

FIG. 5C illustrates a block-on to block-off environment associated with a flight operation in accordance with at least some example embodiments of the present disclosure.

FIG. 5D illustrates an end-to-end block diagram showing example data structures and models for flight operation resource usage prediction and optimization in accordance with at least some example embodiments of the present disclosure.

FIG. 6 is a flowchart diagram of an example process for resource usage prediction and optimization in accordance with at least some example embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### Overview and Technical Improvements

Example embodiments disclosed herein address technical challenges associated with predicting and optimizing resource usage, such as fuel consumption, for flight operations (e.g., flight operations by airlines, cargo operators, etc.). Various factors contribute to fuel consumption. For example, each additional pound of weight carried by an aircraft increases the amount of fuel consumed by the aircraft during flight. Many of these factors may create inefficiencies that may be undetected if not properly monitored. For example, many of these factors can change over time while also having lead times that require early detection of inefficiencies in order to apply appropriate corrective actions.

Example embodiments of the present disclosure provide for periodic monitoring of various factors that contribute to resource usage and efficiency. Example embodiments predict resource usage and efficiency (e.g., fuel savings) periodically for a prospective flight operation based on an end-to-end profile and within a time window preceding the prospective flight operation. For example, embodiments of the present disclosure predict resource usage for a prospective flight operation at a plurality of timestamps within a time window preceding the prospective flight operations. Predicting resource usage over a time window provides for improved resource usage prediction as the as the granularity and degree of definition of the input data leveraged to generate the resource usage predictions increases. Example embodiments optimize for flight path, alternate aircraft, staff roaster (e.g., driven by dynamics of weather, employee availability and fleet availability). Example embodiments incentivize pilots and other users to achieve fuel savings goals. Further, example embodiments project and deliver on sustainability goals.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

As used herein, the term “model” refers to a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or the like. In some examples, one or more models may be configured trained, and/or the like to generate resource usage predictions (e.g., initial resource usage predictions, subsequent resource usage predictions). In some examples, one or more models may be trained using data associated with a plurality of historical flight operations (e.g., previous flight operations). In some examples, one or more models may include one or more supervised, unsupervised, semi supervised, reinforcement learning models, and/or the like. In some examples, one or more models may include multiple models configured to perform one or more different stages of a prediction process.

The term “machine learning model” or “ML model” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a fuzzy-logic-based model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models.

As used herein, the term “resource usage prediction” refers to a data entity that described a model output. A resource usage prediction may describe an amount of resources predicted to be consumed during a prospective flight operation. An example of resource usage prediction includes amount of fuel predicted to be consumed during a flight operation. Another example of resource usage prediction includes amount of energy predicted to be consumed during a flight operation.

As used herein, the term “vehicle identifier” refers to one or more items or elements by which a vehicle, such as an aircraft, may be uniquely identified from other vehicles. The vehicle identifier may be in the form of text string(s), numerical character(s), alphabetical character(s), alphanumeric code(s), American Standard Code for information Interchange (ASCII) characters(s), and/or the like. In some examples, a vehicle identifier comprises make, model, and serial number of an aircraft.

As user herein, the term “prospective flight operation” refers to an aircraft flight from a first location to a second location that is planned to occur at a future date. In some embodiments, a prospective flight operation may be associated with an estimated starting time of operation that describes the planned departure date and/or time for the prospective flight operation. Example prospective flight operation includes planned aircraft flight from a first location to a second location by airlines, cargo operators, or the like.

Thus, use of any such terms, as defined herein, should not be taken to limit the spirit and scope of embodiments of the present disclosure.

### EXAMPLE SYSTEMS AND APPARATUSES OF THE DISCLOSURE

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

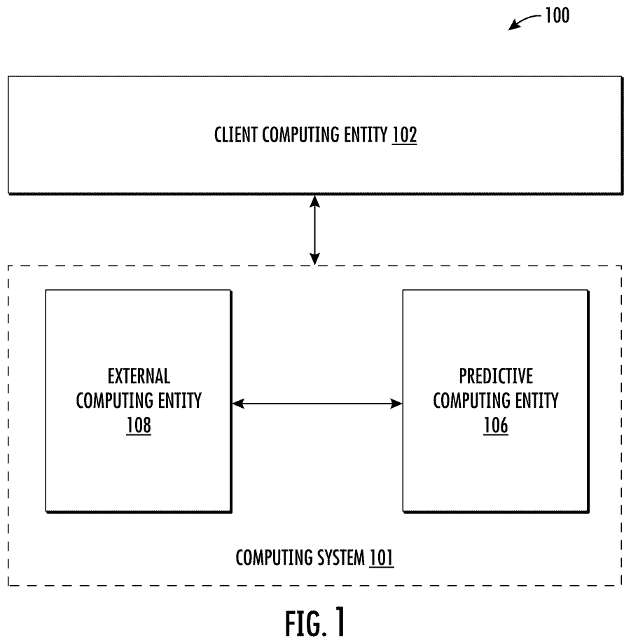

In this regard, FIG. 1 provides an example overview of an architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components.

The architecture 100 includes a computing system 101 configured to receive requests, such as resource usage requests for prospective flight operations, from client computing entities 102, process the requests to generate resource usage prediction outputs, and provide the generated resource usage prediction outputs to the client computing entities 102. The example architecture 100 may be used in a plurality of domains and not limited to any specific application as disclosed herewith. In particular, while some example embodiments are described herein with reference to the aviation domain, the example architecture 100 may be used in a plurality of domains and not limited to any specific application as disclosed herein. The plurality of domains may include aviation, banking, healthcare, industrial, manufacturing, education, retail, to name a few.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive resource usage requests for prospective flight operations from client computing entities 102, process the requests to generate outputs, such as resource usage predictions, and provide the generated outputs to the client computing entities 102.

In some embodiments, the predictive computing entity 106 and/or one or more external computing entities 108 comprise storage subsystems that may be configured to store input data such as aircraft identifier, aircraft data, and/or other relevant data received from one or more data sources, that may be used by the predictive computing entity 106 and/or one or more external computing entities to perform predictive data analysis of the present disclosure. In addition, the storage subsystems may be configured to store model definition data used by the respective computing entities to perform various predictive data analysis. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. In some example embodiments, the predictive computing entity 106 may be configured to receive and/or transmit one or more datasets, objects, and/or the like from and/or to the external computing entities 108 to perform one or more steps/operations of one or more techniques.

### A. Example Predictive Computing Entity

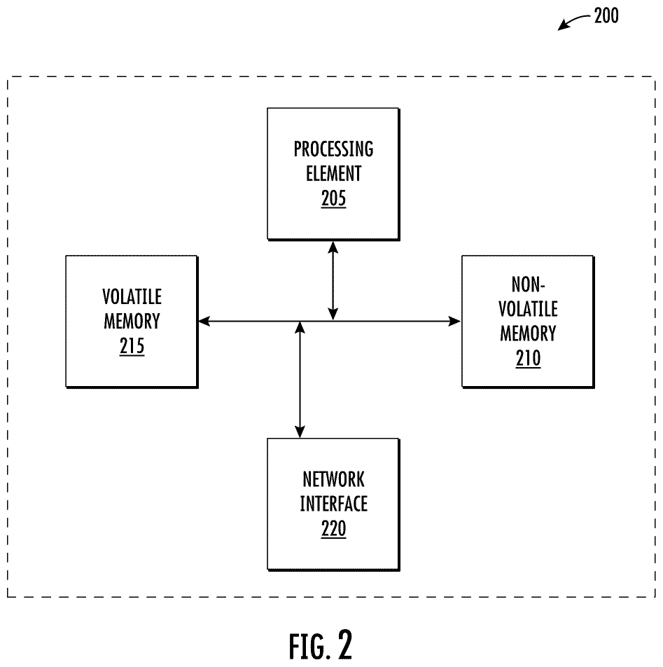

FIG. 2 provides an example computing entity 200 in accordance with at least some example embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

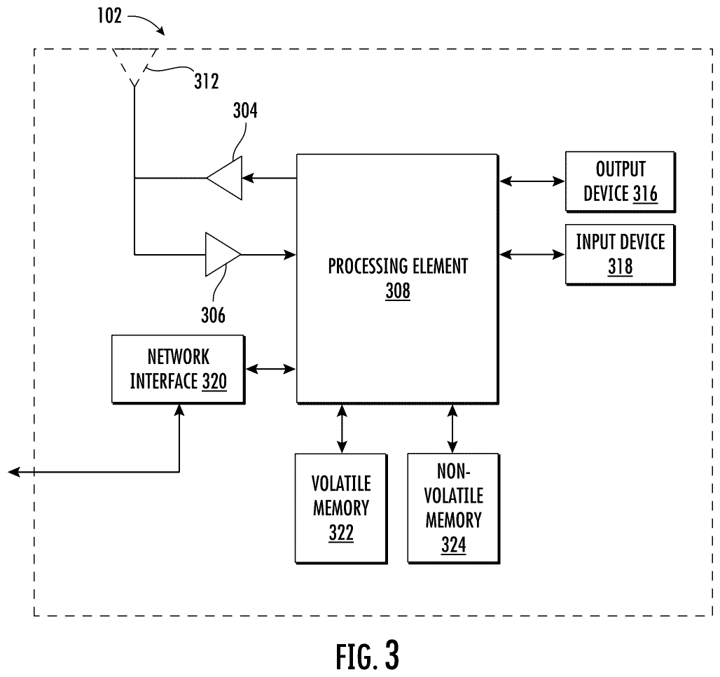

FIG. 3 provides an example client computing entity in accordance with at least some example embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

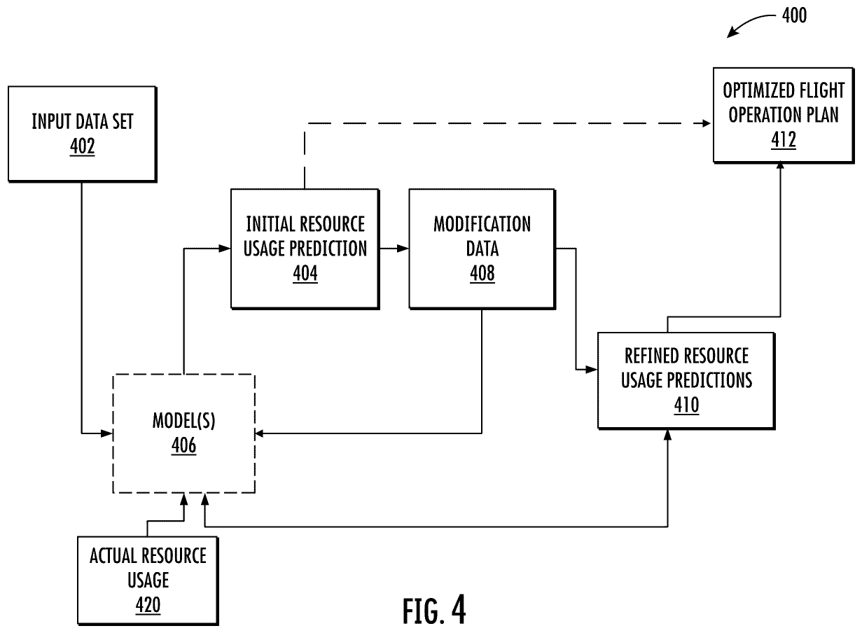

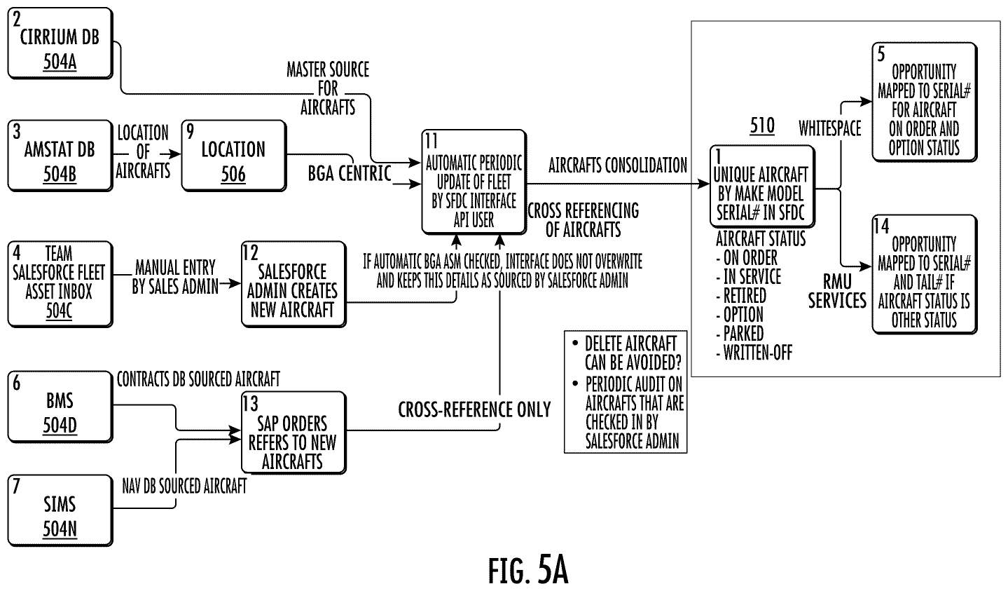

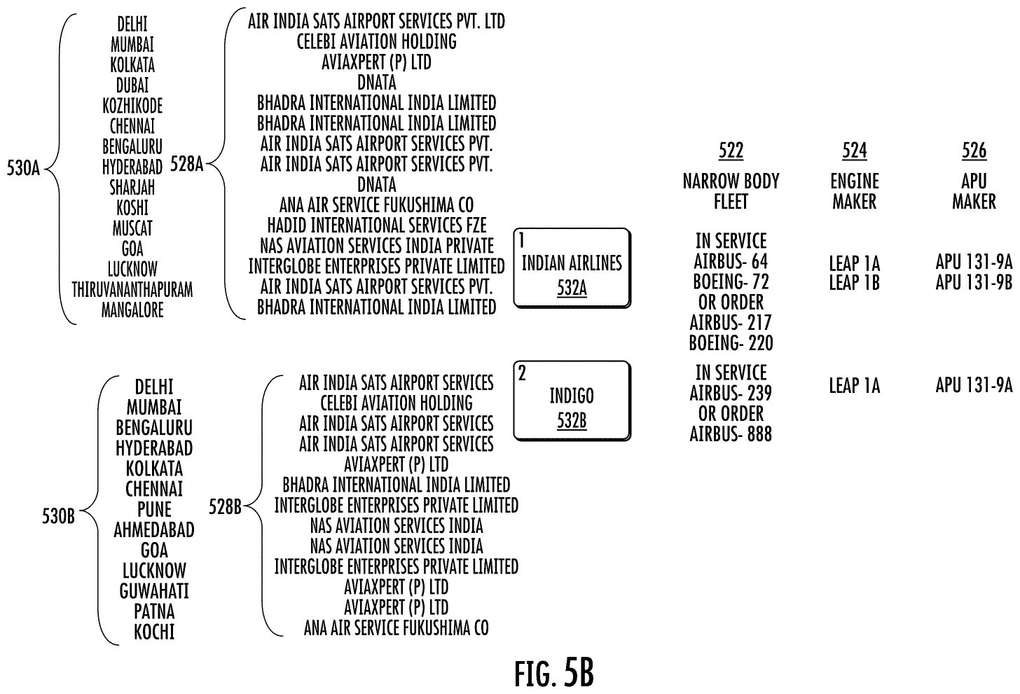

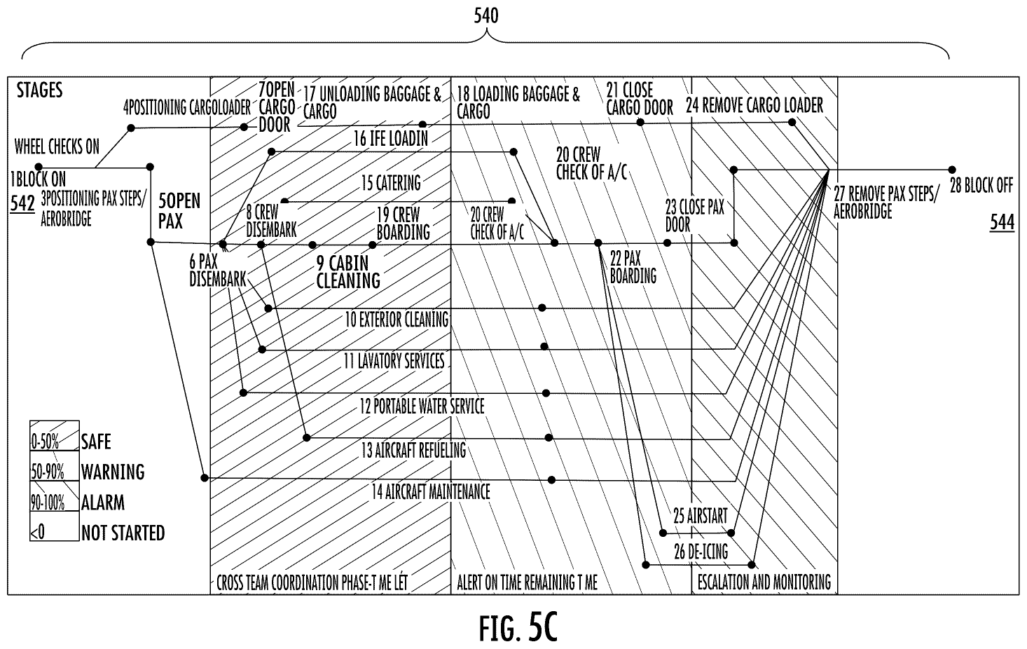

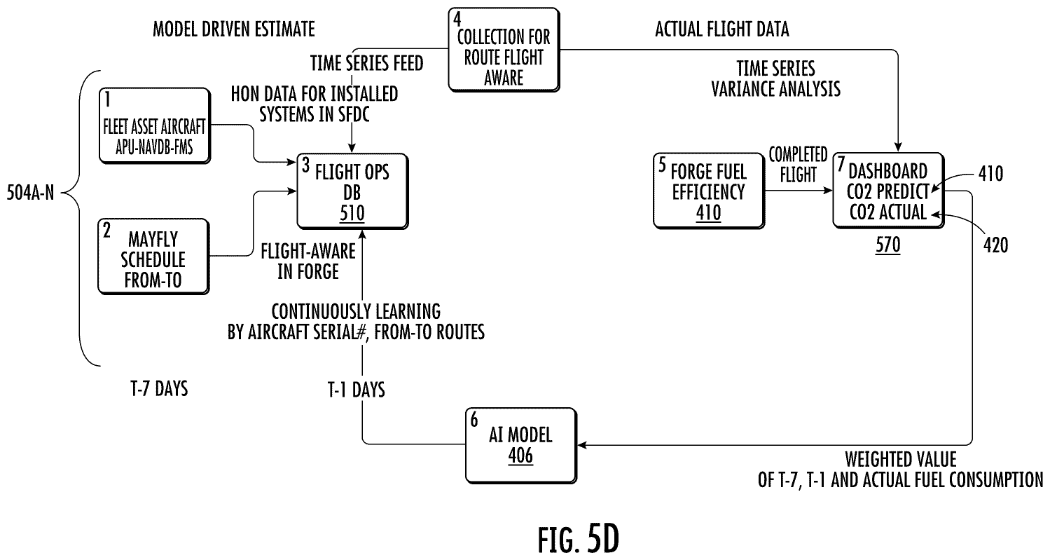

FIG. 4 is a dataflow diagram 400 showing example data structures for resource usage predictions and optimization for a prospective flight operation of an aircraft in accordance with at least some example embodiments of the present disclosure. In some embodiments, input data set 402 is identified for a prospective flight operation having an estimated operating starting timestamp. The estimated operating timestamp for example may describe a date and/or time that the flight operation is scheduled to commence (e.g., date and/or time that an aircraft is scheduled to depart from a first location to a second location). The input data set 402 may correspond to a first timestamp preceding the estimated operating starting timestamp for the prospective flight operation. For example, the input data set 402 may comprise data for the prospective flight operation at a first timestamp preceding the estimated operating starting timestamp for the prospective flight operation. For example, the input data set 402 may comprise data collected prior to the estimated operating timestamp, where the data comprises the current data for one or more input parameters with respect to the first timestamp. For example, if the first timestamp is Jan. 10, 2015, the input data set 402 may comprise the current data for one or more input parameters as of Jan. 10, 2015. In some embodiments, the first timestamp is 30 days prior to the estimated operating starting timestamp (e.g., T-30, where T is the estimated operating starting timestamp). In some embodiments, input parameters describe parameters associated with a flight operation and can be used individually or with other parameters to generate resource usage predictions for a flight operation. Examples of input parameters include aircraft owner, aircraft location, aircraft routes, aircraft type, aircraft body style, aircraft engine manufacturer, aircraft engine type, aircraft auxiliary power unit manufacturer, aircraft auxiliary power unit type, aircraft status (e.g., on order, in service, retired, option, parked, written off, or the like), or the like. The input data set 402 may define an end-to-end profile for the prospective flight operation (e.g., from lock off at the departure location to block on at the arrival location/destination). The input data set 402 may be received, collected, or otherwise accessed from one or more data sources. As further described with reference to FIG. 5A below, in some embodiments, the one or more data sources include external databases and/or internal databases. In example embodiments, the one or more data sources include Mayfly data source for airlines. In some embodiments, the input data set includes a vehicle identifier (e.g., unique identifier for the aircraft associated with the prospective flight operation). In some embodiments, the vehicle identifier comprises make, model, and serial number of the aircraft.

For example, the vehicle identifier may comprise make, model and serial number of the aircraft associated with the prospective flight operation (e.g., the aircraft that is scheduled at the estimated operating starting timestamp to depart from a first location to a second location.) It should be understood that in other embodiments, the vehicle identifier may comprise other data items.

Alternatively, or additionally, in some embodiments, the input data set 402 includes aircraft data for the aircraft associated with the prospective flight operation. Examples of aircraft data include, but not limited to, aircraft owner, aircraft location, aircraft travel path (e.g., including departure location and destination), aircraft routes, aircraft type, aircraft configuration (e.g., body style, engine manufacturer, engine type and/or configuration, auxiliary power unit manufacturer, auxiliary power unit type and/or configuration, etc.), aircraft status (e.g., on order, in service, retired, option, parked, written off, or the like), and/or the like.

Alternatively, or additionally, in some embodiments, the input data set 402 includes information about systems, subsystems, databases, and/or software associated with the aircraft, including onboard systems and databases such as flight management systems and navigation databases. Alternatively, or additionally, in some embodiments, the input data set 402 data includes data about ground operation associated with the prospective flight operation. Alternatively, or additionally, in some embodiments, the input data set 402 includes aircraft weight, number of passengers, crew members, weather condition data and/or other relevant data that may leveraged to predict resource usage for the prospective flight operation.

It will be understood that the input data set 402 may include omit some of the examples provided above and/or may include other data items that may be leveraged to predict resource usage for a flight operation.

In some embodiments, the vehicle identifier may be leveraged to identify one or more portions of the input data set 402. For example, the vehicle identifier may be leveraged to identify and obtain aircraft data. As another example, the vehicle identifier may be leveraged to obtain information about systems, subsystems, software, or the like associated with the aircraft. As yet another example, the vehicle identifier may be leveraged to obtain aircraft weight, number of passengers, crew members, aircraft status, and/or the like.

In some embodiments, the input data set 402 may be extracted from aggregated data obtained from the one or more data sources. For example, the aggregated data may comprise data associated with a plurality of vehicle identifiers, and the input data set 402 associated with the prospective flight operation may be identified and extracted from the aggregated data. In some embodiments, deduplication is performed with respect to the aggregated data to removed duplicate data. The deduplication may be performed with respect to vehicle identifiers, where duplicate data for the same vehicle identifier are removed or otherwise consolidated.

In some embodiments, one or more portions of the input data set 402 may be identified from data stored by the one or more data sources based on a vehicle identifier associated with the prospective flight operation. For example, the data stored by the one or more data sources and associated with the vehicle identifier for the prospective flight operation may be identified and retrieved from the one or more data sources.

In some embodiments, an initial resource usage prediction 404 is generated for the prospective flight operation using one or more models 406 and based on the input data set 402. For example, the one or more models 406 may be applied to the input data set 402 to generate the initial resource usage prediction 404. The input data set 402 may be input to the one or more models 406 configured to process the input data set 402 to generate the initial resource usage prediction. The one or more models may include a neural network, a fuzzy logic-based model, or other models.

In some embodiments, the modification data 408 for one or more sequential subsequent timestamps relative to the first timestamp and preceding the estimated operating starting timestamp is identified for the prospective flight operation. For example, one or more subsequent timestamps relative to the first timestamp may be sampled with respect to one or more input parameters whose data are included in the input data set 402. In some embodiments, the one or more sequential subsequent timestamps include a second timestamp T-5 (e.g., five days prior to the estimated operating timestamp for the prospective flight operation) and a third timestamp T-0 (e.g., 0 days prior to the estimated operating timestamp for the prospective flight operation). It will be appreciated that the one or more sequential subsequent timestamps may include more or less than two timestamps and/or may be timestamps that are different from the above examples. For example, in some embodiments, a subsequent timestamp may be T-15. As another example, in some embodiments, a subsequent timestamp may be T-1.

In some embodiments, the modification data 408 for a subsequent timestamp may comprise data that reflects the difference between the input data set at the subsequent timestamp and the input data set at the immediately preceding timestamp sampled. For example, where the first timestamp is T-30 and the sequential subsequent timestamps comprise a second timestamp T-5 and a third timestamp T-0, the modification data for the second timestamp T-5 may comprise the difference between the input data set 402 at the first timestamp T-30 and the input data set at the second time stamp T-5. Continuing with the example, the modification data for the third timestamp T-0 may comprise the difference between the input data set at the second time stamp T-5 and the input data set at the third timestamp T-0.

For example, the modification data 408 for a subsequent timestamp may reflect the difference between the input data set at the subsequent timestamp and the input data set at the immediately preceding timestamp sampled with respect to a subset of the input parameters whose data are collected and included in the input data set. For example, the modification data may reflect changes with respect to certain dynamic input parameters such as weather condition, number of passengers, personnel data (e.g., operation team availability, crew members), and/or the like. In this regard, identifying the modification data may comprise identifying the data for one or more input parameters (e.g., dynamic input parameters) of a plurality of input parameters at the respective subsequent timestamp and determining the difference between the data for the one or more input parameters at the respective subsequent timestamp and the data for the one or more input parameters at the immediately preceding timestamp sampled. Additionally, In some embodiments, the modification data for a subsequent timestamp may include data for input parameters whose data were not included in the input data set at the immediately preceding timestamp. In some embodiments, one or more models such as one or models 406 may be leveraged to identify modification data for a subsequent timestamp.

In some embodiments, one or more refined resource usage predictions 410 is generated for the prospective flight operation, where each refined resource usage prediction of the one or more refined resource usage predictions is associated with a respective subsequent timestamp of the one or more sequential subsequent timestamps and generated based on the modification data for the respective subsequent timestamp. For example, a refined resource usage prediction at a subsequent timestamp may be generated by applying one or more models such as one or more models 406 to the modification data. In some embodiments, applying the one or more models to the modification data comprise providing the modification data as input to a model of the one or more models, where the model is configured to process the modification data with respect to the input data set and/or the resource usage prediction associated with the immediately preceding timestamp sampled. In some embodiments, applying the one or more models to the modification data comprise providing the input data set at the subsequent timestamp to a model of the one or more models configured to process the input data set and output a refined resource usage prediction, where the model may identify the modification data as an intermediate output and leverage the modification data to generate the refined resource usage prediction.

In some embodiments, a refined resource usage prediction associated with a subsequent timestamp is generated based on the input data set at the subsequent timestamp. In such embodiments, identifying the modification data for the subsequent timestamp may not be needed. For example, the input data set at the subsequent timestamp may be identified and provided as input to the one or more models 406, where the one or more models 406 may be configured to process the input data set at the subsequent timestamp and output resource usage prediction that represents a refined resource usage prediction relative to the resource usage prediction associated with the immediately preceding timestamp sampled. For example, in some embodiments, generating the one or more refined resource usage predictions for the prospective flight operation comprise for each subsequent timestamp of the one or more sequential subsequent timestamps identifying a respective input data set corresponding to the subsequent timestamp, and generating a refined resource usage corresponding to the subsequent timestamp by applying the one or more models to the respective input data set.

In some embodiments, performance of one or more prediction-based actions is initiated based on one or more of the initial resource usage predictions or the one or more refined resource usage predictions. In some embodiments, initiating performance of one or more prediction-based actions based on one or more of the initial resource usage predictions or the one or more refined resource usage predictions comprises optimizing resource usage for the prospective flight operation in response to the result of analysis and/or evaluation of the initial resource usage predictions or the one or more refined resource usage predictions.

For example, the initial resource usage predictions or the one or more refined resource usage predictions may be analyzed to determine if there are inefficiencies and/or opportunities to reduce resource usage. For example, the initial resource usage predictions or the one or more refined resource usage predictions may be compared to one or more key performance indicator thresholds (e.g., fuel consumption threshold, sustainability goals, cost, or the like) to determine if there are inefficiencies in the current flight operation plan and/or if there are opportunities to reduce resource usage for the prospective flight operation or otherwise improve the key performance indicators. An optimized flight operation plan 412 that includes recommendations configured to reduce actual resource usage for the prospective flight operation relative to the initial resource usage prediction or the one or more refined resource usage predictions may then be generated. An actual resource usage may describe the amount of a particular resource that is consumed during the flight operation (e.g., from block on to block off). For example, the actual resource usage may be the amount of fuel consumed during the flight operation e.g., from block on to block off). In some embodiments, the actual resource usage 420 for the prospective flight operation and the refined resource usage predictions 410 may be leveraged to re-train or fine-tune the one or more models to facilitate continuous learning and improve the accuracy of the output of the one or more models. For example, the actual resource usage 420 for the prospective flight operation and the refined resource usage predictions 410 (e.g., the refined resource usage prediction associated with the latest subsequent timestamp (e.g., T-0)) may form a portion of a training dataset used to re-train or fine-tune to one or more models 406.

In this regard, in some embodiments, optimizing resource usage for a prospective flight operation includes identifying and recommending opportunities for reduced resource usage. For example, initiating the performance of one or more prediction-based actions may comprise recommending an optimized flight operation plan 412 configured to reduce resource usage for the flight operation. The optimized flight operation may include one or more of recommended alternate routes/flight paths for the prospective flight operation; recommended configuration changes to one or more systems, auxiliary power units, and/or other components of the aircraft associated with the flight operation; recommended personnel schedule; recommended ground operation plan, or the like.

Alternatively, or additionally, in some embodiments, optimizing resource usage for a prospective flight operation includes generating an alert that describes areas of inefficiencies with respect to the current flight operation plan and providing the alert to a user at a suitable time that allows for actions to be taken to address the identified inefficiencies.

In some embodiments, initiating the performance of the one or more prediction-based actions comprises causing rendering of a user interface on a display of a client computing entity associated with a user, where the user interface comprises optimized flight operation plan 412 and/or alerts (as described above). Alternatively, or additionally, in some embodiments, initiating the performance of one or more prediction-based actions comprises providing the initial resource usage prediction and/or the one or more refined resource usage predictions to a user. For example, a user interface comprising the initial resource usage prediction and/or the one or more refined resource usage predictions may be caused to be rendered on a display of a client computing entity.

FIG. 5A illustrates a data environment for input data aggregation in accordance with at least some example embodiments of the present disclosure. As described above, the input data sets for generating resource usage predictions (e.g., initial resource usage predictions and one or mor sequential subsequent resource usage predictions) may be obtained from aggregated data from one or more data sources such as data sources 504A-N. The one or more data sources may include external data sources (e.g., public data sources) and/or internal data source (associated with the computing system 101 and/or entity associated with the computing system 101). In the illustrated example in FIG. 5A, the public data sources may include Cirrium database 504A, AMSTAT database 504B, and Team Salesforce Fleet Asset Inbox 504C. In the illustrated example in FIG. 5A, the internal data sources may include BMS 504D and SIMS 504N. As shown in FIG. 5A, in some examples, the Cirrium database 504A may represent the master source for aircraft data and the AMSTAT database 504B may be leveraged to obtain aircraft location data that describes the location of an aircraft.

One or more operations may be performed on the aggregated data obtained from the one or more data sources 504A-N to identify and extract one or more portions of the input data sets leveraged to generate the resource usage predictions (e.g., initial resource usage prediction, subsequent resource usage predictions). The one or more operations may include deduplication as described above with reference to FIG. 4, cross referencing (e.g., cross referencing aircrafts), data entries, and/or the like. As shown in FIG. 5A, the one or more operations may include consolidating the aggregated data or otherwise organization the aggregated by vehicle identifier (e.g., make, model, and serial number) along with the aircraft status (e.g., on order, in service, retired, option, parked, written off, or the like) into a flight operation database 510. The vehicle identifier and the aircraft status may be leveraged to identify opportunities mapped to the serial number for aircrafts on order or option status, opportunities mapped to serial number and tail numbers if aircraft status has a different/other status.

FIG. 5B illustrate examples of certain input parameters in accordance with at least some example embodiments of the present disclosure. Specifically, FIG. 5A illustrates examples of certain input parameters along with example data for the certain input parameters. FIG. 5B shows example data for aircraft status 522, aircraft engine manufacturer 524, auxiliary power unit manufacturer 526, cities 530A, 530B were an aircraft flies to and/or from, airport 528A, 528B were an aircraft flies to and/or from, etc. In some examples at least a portion of the input parameters may be associated with an airline such as airlines 532A-B illustrated in FIG. 5B.

FIG. 5C illustrates a block-on to block-off environment associated with a flight operation in accordance with at least some example embodiments of the present disclosure. As shown in FIG. 5C, a plurality of activities 540 may be performed by various entities (e.g., crew members, ground crew, engineers, and/or the like). In some embodiments, a portion of the input data sets leveraged to generated resource usage predictions may include data associated with one or more of the plurality activities from block-on 542 to block-off 544.

FIG. 5D illustrates an end-to-end block diagram showing example data structures and models for flight operation resource usage prediction and optimization in accordance with at least some example embodiments of the present disclosure. As shown in FIG. 5D, the data from one or more data sources 504A-N may be ingested into a flight operation database 510 and/or leveraged to generate resource usage predictions (e.g., initial resource usage predictions, refined resource usage predictions) and/or optimized flight operation plans.

In some embodiments, the resource usage predictions comprise fuel consumption predictions. In some embodiments, greenhouse gas emissions such as carbon dioxide (CO2) emissions may be calculated or otherwise determined from the resource usage predictions. In some embodiments, the resource usage predictions may comprise greenhouse gas emissions. For example, the resource usage predictions output by the one or more models 406 may comprise fuel consumption predictions and/or greenhouse gas emissions predictions. In some embodiments, the fuel consumption predictions and/or greenhouse gas emissions predictions (e.g., at least the latest refined resource usage predictions (e.g., at T-0)) may be rendered on a dashboard (e.g., via a user interface). Additionally, or alternatively, the actual resource usage 420 (e.g., actual fuel consumed during the flight operation and/or actual greenhouse gas emitted during the flight operation) may be determined (e.g., via time series analysis, or the like) and displayed on the dashboard 570 (e.g., via a user interface). As shown in FIG. 5D, the resource usage predictions and/or the actual resource usage 420 may be provided as input to the one or more models 406 (which may include artificial intelligence models) to re-train or fine-tune the one or more models 406 so as to facilitate continuous learning and improve the accuracy of the output of the one or more models.

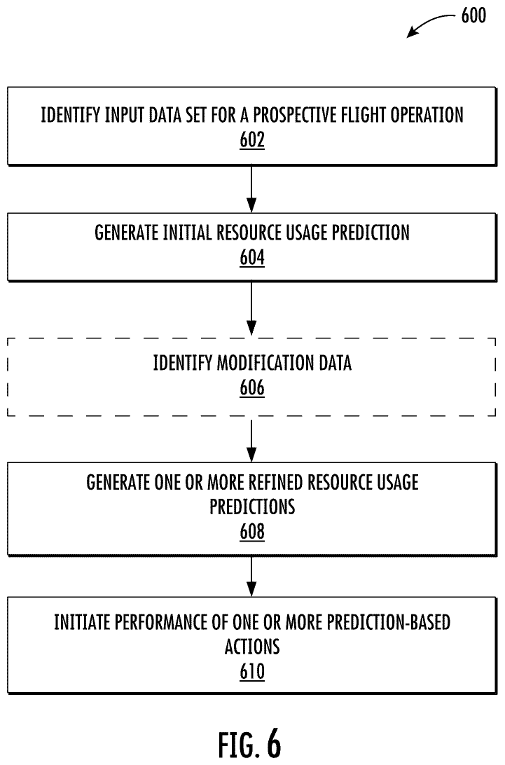

FIG. 6 is a flowchart diagram of an example process 600 for resource usage prediction and optimization in accordance with at least some example embodiments of the present disclosure. The process 600 may be implemented by one or more computing devices, entities, and/or systems described herein. For example, via the various steps/operations of the process 600, the computing system 101 may generate resource usage predictions for a prospective flight operation over a time window preceding the prospective operation configured optimize resource usage such as fuel savings.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, identifying an input data set for a prospective flight operation. For example, the computing system 101 may identify an input data set corresponding to a first timestamp for a prospective flight operation having an estimated operating starting timestamp. As described above, the estimated operating timestamp may describe a date and/or time that the flight operation is scheduled to commence (e.g., date and/or time that an aircraft is scheduled to depart from a first location to a second location). The input data set 402 may comprise data for the prospective flight operation at a first timestamp preceding the estimated operating starting timestamp for the prospective flight operation. In some embodiments, the first timestamp is thirty (30) days prior to the estimated operating starting timestamp (e.g., T-30, where T is the estimated operating starting timestamp).

In some embodiments, the process 600 includes, at step/operation 604, generating initial resource usage prediction for the prospective flight operation. For example, the computing system 101 may generate initial resource usage prediction for the prospective flight operation using one or more models and based on the input data set. For example, at least one of the one or more models may be applied to the input data set 402 to generate the initial resource usage prediction. In some embodiments, the at least one model includes a machine learning resource usage model.

In some embodiments, the process 600 includes, at step/operation 606, identifying modification data for one or more sequential subsequent timestamps. For example, the computing system 101 may identify modification data for one or more sequential subsequent timestamps relative to the first timestamp and preceding the estimated operating starting timestamp. In some embodiments, the one or more sequential subsequent timestamps include a second timestamp T-5 (e.g., five (5) days prior to the estimated operating timestamp for the prospective flight operation) and a third timestamp T-0 (e.g., zero (0) days prior to the estimated operating timestamp for the prospective flight operation). In some embodiments modification data for a subsequent timestamp may comprise data that reflects the difference between the input data set at the subsequent timestamp and the input data set at the immediately preceding timestamp sampled.

In some embodiments, the process 600 includes, at step/operation 608, generating one or more refined resource usage predictions for the prospective flight operation. In some embodiments, the computing system 101 may generate one or more refined resource usage predictions for the prospective flight operation corresponding to the one or more sequential subsequent timestamps based on the modification data. For example, a refined resource usage prediction at a subsequent timestamp may be generated by applying one or more models such as one or more models 406 to the modification data. In some embodiments, applying the one or more models to the modification data comprise providing the modification data as input to a model of the one or more models, where the model is configured to process the modification data with respect to the input data set and/or the resource usage prediction associated with the immediately preceding timestamp sampled. In some embodiments, applying the one or more models to the modification data comprise providing the input data set at the subsequent timestamp to a model of the one or more models configured to process the input data set and output a refined resource usage prediction, where the model may identify the modification data as an intermediate output and leverage the modification data to generate the refined resource usage prediction.

In some embodiments, step/operation 606 may be an optional step. In such some embodiments, a refined resource usage prediction associated with a subsequent timestamp may be generated based on the input data set at the subsequent timestamp. For example, the input data set at the subsequent timestamp may be identified and provided as input to the one or more models, where the one or more models may process the input data set and output resource usage prediction that represents a refined resource usage prediction relative to the resource usage prediction associated with the immediately preceding timestamp sampled. In some embodiments, the initial resource usage prediction and the one or more refined resource usage predictions each comprise predicted fuel consumption for the prospective flight operation.

In some embodiments, the process 600 includes, at step/operation 610, initiating performance of one or more prediction-based actions. For example, the computing system 101 may initiate performance of one or more prediction-based actions based on one or more of the initial resource usage predictions or the one or more refined resource usage predictions. In some embodiments, initiating performance of one or more prediction-based actions based on one or more of the initial resource usage predictions or the one or more refined resource usage predictions comprises optimizing resource usage for the prospective flight operation in response to the result of analysis and/or evaluation of the initial resource usage predictions or the one or more refined resource usage predictions.

In some embodiments, initiating performance of one or more prediction-based actions comprises optimizing resource usage for the prospective flight operation by identifying and recommending opportunities for reduced resource usage (e.g., alternate routes/flight path for the prospective flight operation that will result in less resource usage, operational team staffing plan that will result in less resource usage, ground operation plan that will result in less resource usage, etc.), generating an alert that describes areas of inefficiencies and providing the alert to a user at a suitable time that allows for actions to be taken to address the identified inefficiencies, and/or the like. In some embodiments, initiating the performance of the one or more prediction-based actions comprises causing rendering of a user interface on a display of a client computing entity associated with a user, where the user interface comprises resource usage reduction recommendations or alerts (as described above). Alternatively, or additionally, in some embodiments, initiating the performance of one or more prediction-based actions comprises providing the initial resource usage prediction and/or the one or more refined resource usage predictions to a user. For example, a user interface comprising the initial resource usage prediction and/or the one or more refined resource usage predictions may be caused to be rendered on a display of a client computing entity.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for flight operation resource usage prediction and optimization, the computer-implemented method comprising:
identifying an input data set for a prospective flight operation having an estimated operating starting timestamp, the input data set associated with a first timestamp preceding the estimated operating starting timestamp for the prospective flight operation.
generating initial resource usage prediction for the prospective flight operation by applying one or more models to the input data set.
generating, one or more refined resource usage predictions for the prospective flight operation, each refined resource usage prediction of the one or more refined resource usage predictions associated with a subsequent timestamp of one or more sequential subsequent timestamps relative to the first timestamp and preceding the estimated operating starting timestamp for the prospective flight operation; and
initiating performance of one or more prediction-based actions based on one or more of the initial resource usage prediction or the one or more refined resource usage predictions.

2. The computer-implemented method of claim 1, wherein generating the one or more refined resource usage predictions for the prospective flight operation comprises:
for each subsequent timestamp of the one or more sequential subsequent timestamps:
identifying a respective input data set; and
generating a refined resource usage by applying the one or more models to the respective input data set.

3. The computer-implemented method of claim 1, wherein the initial resource usage prediction and the one or more refined resource usage predictions each comprises predicted fuel consumption for the prospective flight operation.

4. The computer-implemented method of claim 1, wherein initiating the performance of one or more prediction-based actions comprises:
comparing the initial resource usage prediction or the one or more refined resource usage predictions to one or more key performance indicator thresholds; and
generating an optimized flight operation plan that comprises recommendations configured to reduce actual resource usage for the prospective flight operation relative to the initial resource usage prediction or the one or more refined resource usage predictions.

5. The computer-implemented method of claim 1, wherein initiating the performance of one or more prediction-based actions comprises providing one or more of the initial resource usage prediction or the one or more refined resource usage predictions to a user.

6. The computer-implemented method of claim 1, further comprising:
identifying modification data for the one or more sequential subsequent timestamps; and
generating the one or more refined resource usage predictions comprises applying the one or more models to the modification data.

7. The computer-implemented method of claim 1, wherein the one or more models comprise a neural network.

8. The computer-implemented method of claim 1, wherein at least a portion of the input data set is obtained from one or more data sources based on a vehicle identifier associated with the prospective flight operation.

9. The computer-implemented method of claim 8, wherein the vehicle identifier comprises make, model, and serial number of an aircraft associated with the prospective flight operation.

10. The computer-implemented method of claim 1, wherein the first timestamp is 30 days prior to the estimated operating starting timestamp and the one or more sequential subsequent timestamps comprises a second timestamp that is five days prior to the estimated operating starting timestamp and a third timestamp that is zero days prior to the estimated operating starting timestamp.

11. A computing system for flight operation resource usage prediction and optimization, the computing system comprising memory and one or more processors communicatively coupled to the memory, the one or more processors configured to:
identify an input data set for a prospective flight operation having an estimated operating starting timestamp, the input data set associated with a first timestamp preceding the estimated operating starting timestamp for the prospective flight operation.
generate initial resource usage prediction for the prospective flight operation by applying one or more models to the input data set.
generate, one or more refined resource usage predictions for the prospective flight operation, each refined resource usage prediction of the one or more refined resource usage predictions associated with a subsequent timestamp of one or more sequential subsequent timestamps relative to the first timestamp and preceding the estimated operating starting timestamp for the prospective flight operation; and
initiate performance of one or more prediction-based actions based on one or more of the initial resource usage prediction or the one or more refined resource usage predictions.

12. The computing system of claim 11, wherein the one or more processors are further configured to generate the one or more refined resource usage predictions for the prospective flight operation by:
for each subsequent timestamp of the one or more sequential subsequent timestamps:
identifying a respective input data set; and
generating a refined resource usage by applying the one or more models to the respective input data set.

13. The computing system of claim 11, wherein the initial resource usage prediction and the one or more refined resource usage predictions each comprises predicted fuel consumption for the prospective flight operation.

14. The computing system of claim 11, wherein the one or more processors are further configured to initiate the performance of one or more prediction-based actions by:
comparing the initial resource usage prediction or the one or more refined resource usage predictions to one or more key performance indicator thresholds; and
generating an optimized flight operation plan that comprises recommendations configured to reduce actual resource usage for the prospective flight operation relative to the initial resource usage prediction or the one or more refined resource usage predictions.

15. The computing system of claim 11, wherein the one or more processors are further configured to initiate the performance of one or more prediction-based actions by providing one or more of the initial resource usage prediction or the one or more refined resource usage predictions to a user.

16. The computing system of claim 11, wherein the one or more processors are further configured to:
identify modification data for the one or more sequential subsequent timestamps; and
generate the one or more refined resource usage predictions by applying the one or more models to the modification data.

17. The computing system of claim 11, wherein the one or more models comprise a neural network.

18. The computing system of claim 11, wherein at least a portion of the input data set is obtained from one or more data sources based on a vehicle identifier associated with the prospective flight operation.

19. The computing system of claim 18, wherein the vehicle identifier comprises make, model, and serial number of an aircraft associated with the prospective flight operation.

20. At least one non-transitory computer-readable storage medium for flight operation resource usage prediction and optimization, the at least one non-transitory computer-readable storage medium having computer coded instructions configured to, when executed by at least one processor:
Identify an input data set for a prospective flight operation having an estimated operating starting timestamp, the input data set associated with a first timestamp preceding the estimated operating starting timestamp for the prospective flight operation.
generate initial resource usage prediction for the prospective flight operation by applying one or more models to the input data set.
generate, one or more refined resource usage predictions for the prospective flight operation, each refined resource usage prediction of the one or more refined resource usage predictions associated with a subsequent timestamp of one or more sequential subsequent timestamps relative to the first timestamp and preceding the estimated operating starting timestamp for the prospective flight operation; and
initiate performance of one or more prediction-based actions based on one or more of the initial resource usage prediction or the one or more refined resource usage predictions.
